(19) United States
(12) Patent Application Publication
(10) Pub. No.: US 2022/0206879 A1
(43) Pub. Date: Jun. 30, 2022

(54) PCIe Race Condition secure by Trait Claims and Address Space by using Portable Stimulus

(71) Applicant: Subhas Kumar Basu, Bellevue, WA (US)

(72) Inventor: Subhas Kumar Basu, Bellevue, WA (US)

(73) Assignee: Heena Bhatia, Bellevue, WA (US)

(21) Appl. No.: 17/247,912

(22) Filed: Dec. 30, 2020

(51) Int. Cl. G06F 9/52; G06F 13/42

(52) U.S. Cl. CPC G06F 9/526; G06F 2213/0026; G06F 13/4221

(57) ABSTRACT

As part of PCIe enumeration, switches and endpoint devices allocate memory from three PCIe slave address spaces of the HOST. Multi-CPUs cause a Race Condition during Enumeration. Suppose CPU1 initiate a transaction on Address Port CF8 data is to be written to Data Port CFC. Another CPU2 may write on Address Port CF8 before the CPU1 has been able to write to Data Port leading to a race condition. This may be avoided using Traits to avoid conflict and Race Condition. Allocation of Address Space region (Contiguous) for TYPE0 or TYPE1 Configuration space is achieved using Byte Addressability by PCIe End Point devices. PCIe devices shall claim this Configuration Space region when it wishes to operate on it. An allocation claim uses a trait to map to Configuration Spaces from address space. Configuration Space with traits that satisfy the claim's trait constraints is the candidate for matching regions

Using these concepts as givin in abstract, we are defining Contiguous Address Space within the PCIe environment and making a claim to a specific address space using a trait “owned” by the CPU. Other CPUs in a multi CPU environment will not be able to access the address space since the trait is not matching when claimed by the CPU's trait.

Use the handle “src_handle” or “dst_handle” to check if write to ADDR PORT has been initiated already by having a handle from claim written on the Address Port at Address Port CF8. Or use a temporary variable to record handle and check against that, so if a different CPU attempts to write to the Address Port before the first CPU having written to the Data Port at CFC, it will not be able to since the make handle value will be different.

Typically, the traits are defined prior to the address space declarations, but being shown here to demonstrate the claim and matching using traits.

In the following code, the Configuration Space has been defined in two structs, so that TRAIT (which is an extension of the PSS v1.1 Library Struct TRAIT) is addressable. This struct is then extended to include all the variables and fields as bit datatypes.

Regions in Address Space can be claimed by passing traits (as parameterized) in declarative PSS model inside actions using the instances of addr_claim_s. The act of creating the instances of addr_claim_s is allocating the memory. Address Space handles are created to perform primitive operations on the claimed regions.

PSS core library functions are being used to create a handle from an address space allocation claim—addr_handle_t, make_handle_from_claim

NOTE: The commented highlighted lines are proposed PSS2.0 library struct, functions, components, etc. which are parameterized and unavailable in current tools, hence using global variables to demonstrate. (it's marked in bold italics)

Address Spaces Declaration

```
struct addr_region_base_s {
    bit[512] size;
};

[symbol]

[symbol]

struct addr_region_s:addr_region_base_s
{
        pciever_traits_s pciver_trait;
        config_space_s pcics_trait;
};

[symbol]

[symbol]

[symbol]


  struct transparent_addr_region_s:addr_region_s{
      bit[512] addr;
  };
  // from DSL Library
  component addr_space_base_c{
  }

[symbol]

[symbol]

[symbol]

[symbol]

  contiguous_addr_space_c:addr_space_base_c
  {

[symbol]

[symbol]

        function void add_region( );

[symbol]

[symbol]

[symbol]

        add_nonallocatable_region( );
        bool byte_addressable = true;
  };

[symbol]

[symbol]

[symbol]

  component transparent_addr_space_c:
  contiguous_addr_space_c
  {
        // It is illegal to pass a non-transparent region to the

[symbol]

  }
```

PSS Top Declaration

```
component pss_top{
}
extend component pss_top {
    my_ip ip;

[symbol]

[symbol]

    transparent_addr_space_c sys_mem;

[symbol]

[symbol]

    transparent_addr_space_c local_mem;
    transparent_addr_region_s r0;
    transparent_addr_region_s r1;
    exec init {

[symbol]

[symbol]

[symbol]

[symbol]


        r0.size = 1024;
        r0.addr = 4096;
        r0.trait.ctype = WB;
        r0.trait.sec_level = level0;
        r1.size = 1024;
        r1.addr = 0;

[symbol]

[symbol]


        sys_mem.add_region( );

[symbol]

        local_mem.add_region( );
    }
    action trait{
      exec post_solve{
        display(“r0.size=%d”,r0.size, “t”,“r0.addr=%d/n”,r0.addr,
        “r1.size=%d/n”,r1.size,
        “r1.addr=%d/n”,r1.addr,
        “r0.trait.ctype=%s/n”,r0.trait.ctye,
        “r0.trait.sec_level=%s/n”,r0.trait.sec_level);
  }
  }
}
```

Struct Traits Declaration

```
struct TRAIT{ };
enum pcie_attr_e {PCI, PCIe, PCIe2, PCIe3}
enum security_level_e {level0, level1, level2, level3};
struct pciever_traits_s:TRAIT {
  rand pcie_attr_e ctype;
  rand security_level_e sec_level;
}
extend struct TRAIT{
  bit[15:0] vendor_id;
  bit[15:0] device_id;
};
struct config_space_s:TRAIT{
    bit[15:0] command;
    bit[15:0] status;
    bit[7:0] revision_id;
    bit[22:0] class_code;
    bit[7:0] cache_line_size;
    bit[7:0] latency_timer;
    bit[7:0 header_type; // type0 or type1
    bit[7:0] bist;
    bit[31:0] base_addr_reg1;
    bit[31:0] base_addr_reg2;
    bit[31:0] base_addr_reg3;
    bit[31:0] base_addr_reg4;
    bit[31:0] base_addr_reg5;
    bit[31:0] base_addr_reg6;
    bit[31:0] reserve1;
    bit[31:0] reserve2;
    bit[31:0] ext_ROM_base_addr;
    bit[31:0] reserve3;
    bit[31:0] reserve4;
    bit[7:0] intr_line;
    bit[7:0] intr_pin;
    bit[7:0] min_grant;
    bit[7:0] max_latency;
  }
```

Address Space Claim Using Traits

```

[symbol]

[symbol]

      struct addr_claim_s{
      }
      extend struct addr_claim_s{
        TRAIT trait_claim;
      }
    buffer data_buff {

[symbol]

[symbol]

            rand addr_claim_s mem_seg;
  };
  pool data_buff db;
  bind db*;
    action trait{
          input data_buff src_buff;
          output data_buff dst_buff;
          constraint dst_buff.mem_seg.trait_claim.device_id == src_buff.mem_seg.trait_claim.device_id;

[symbol]

[symbol]

src_handle = make_handle_from_claim(src_mem);
dst_handle = make_handle_from_claim(dst_mem);
}
The address handles are declared and then used in exec body
struct addr_handle_t{
}
extend struct addr_handle_t{
          bit[63:0] addr_handle_t;
}
component make_handle{
          function void make_handle_from_claim( );
          function void addr_value( );
}
addr_handle_t src_handle, dst_handle;
          exec body {
            src_handle = make_handle_from_claim(src_mem);
            dst_handle = make_handle_from_claim(dst_mem);
            bit[64] src_addr = addr_value(src_handle) >> 2;
            bit[64] dst_addr = addr_value(dst_handle) >> 2;
          };
```

1. A method of making PCIe Address Port at CF8 claimable, the claim is closed and comprising; a) parameterized Traits of Address Space of a Region using language constructs for DSL to tag the Address Space as an handle; b) forming a lock on the Address Port by claiming the address space using the trait handle for the duration of time it takes to write Configuration Space data by a CPU to Data Port at CFC; resulting in other CPU (in a multiple CPU environment) be unable to write data (since the trait being used is different from the “locked” trait for the Address Port and thereby resolving PCIe Race Condition.
